(19) United States
(12) Patent Application Publication
(10) Pub. No.: US 2008/0244273 A1
(43) Pub. Date: Oct. 2, 2008

(54) CRYPTOGRAPHIC METHOD USING REDUNDANT BITS AND ADAPTIVE CLOCK FREQUENCY

(76) Inventors: Oscal Tzyh-Chiang CHEN, Min-Hsiung (TW); Meng-Lin HSIA, Min-Hsiung (TW)

Correspondence Address: SINORICA, LLC, 528 FALLSGROVE DRIVE, ROCKVILLE, MD, 20850, US

(21) Appl. No.: 11/757,326

(22) Filed: Jun. 1, 2007

(30) Foreign Application Priority Data
Mar. 27, 2007 (TW) 096110563

(51) Int. Cl. H04L 9/00; G06F 7/58

(52) U.S. Cl. 713/189; 708/252

(57) ABSTRACT

The present invention discloses a cryptographic method using redundant bits and an adaptive clock frequency, which adds redundant bits and modifies clock frequency to change the contents and transmission rate of the bit sequence to encrypt data. The present invention can combine with the existing security mechanism or cryptographic algorithm, such as AES (Advanced Encryption Standard) or DES (Data Encryption Standard), to achieve a multi-fold security function. Thereby, the present invention can apply to various communication devices to increase the immunity against attacks, promote information security and protect personal privacy.

### BACKGROUND OF THE INVENTION

1. Field of the Invention

The present invention relates to a cryptographic method, particularly to a cryptographic method using redundant bits and an adaptive clock frequency.

2. Description of the Related Art

With the popularization of mobile communication and the arrival of the multimedia age, there is always massive confidential information transmitted via wireless communication at anytime. Thus, many mechanisms of information security are being developed or improved in order to achieve higher security, lower complexity and lower cost.

At present, information security has the following strategies:
(1) Innovating or Improving Digital Encryption Circuits: It is the most commonly used cryptographic method, wherein microcontrollers, registers, memories, comparators, counters, etc., are used to realize the algorithm for an encryption circuit or a security mechanism. However, such a circuit is usually bulky and complicated.
(2) Protecting Data via Controlling Data Frequencies: This method utilizes a frequency detector to modify clock, wherein the clock frequency of confidential data is modified according to a special mode, and data is then transmitted at unfixed frequencies to realize information security. Such a method has been used in transponders.
(3) Reading confidential data within random periods: In this method, confidential data is read from registers within random periods under a special condition, and the random periods are generated by a pseudo random number generator.
(4) Protecting data via adding security bits: This method adds a security bit to each byte in a memory array. When the security bit is set to be active, the corresponding byte cannot be written into. Thus, the data in the byte is protected.

The abovementioned methods (1), (3) and (4) lay stress on the improvement of circuits; therefore, the circuits thereof are usually bulky, complicated, expensive and hard to design. The abovementioned method (2) is dedicated to analog circuits and not widely adopted. To overcome the problems of the conventional technologies, the present invention proposes a cryptographic method using redundant bits and an adaptive clock frequency, whereby the information security is enhanced, the design time is shortened, and the fabrication cost is reduced.

### SUMMARY OF THE INVENTION

The present invention discloses a cryptographic method using redundant bits and an adaptive clock frequency, wherein via adding redundant bits to the original bit sequence, the complexity of a bit sequence is increased; via modifying the analog/digital architecture of the original circuit, the cryptographic method of the present invention can combine with the original security mechanisms to achieve a multi-fold security function. The cryptographic method of the present invention comprises the following steps: determining the bit number of the original bit sequence and the bit number of a redundant bit sequence; merging the redundant bit sequence into the original bit sequence; modifying the original clock frequency to attain a clock frequency adaptive to the merged bit sequence; and outputting the merged bit sequence and the adaptive clock frequency to the rear end for further processing.

The embodiments will be described in detail below in cooperation with the drawings to make the persons skilled in the art easily understand the technical means, characteristics and accomplishments of the present invention.

### BRIEF DESCRIPTION OF THE DRAWINGS

FIG. 1 is a block diagram schematically showing the architecture of a conventional integrated analog/digital system;

FIG. 2 is a block diagram schematically showing the circuit architecture of the present invention;

FIG. 3 is a block diagram schematically showing the architecture of a RFID tag;

FIG. 4 is a block diagram schematically showing the architecture of a digital signal processing unit;

FIG. 5 is a block diagram schematically showing the architecture of a RFID tag according to one embodiment of the present invention;

FIG. 6 is a diagram showing the clock signal according to one embodiment of the present invention;

FIG. 7 is a diagram showing the bit sequences according to one embodiment of the present invention;

FIG. 8 is a block diagram schematically showing the architecture of a clock generator;

FIG. 9 is a block diagram schematically showing the architecture of a digital signal processing unit capable of generating PRBS;

FIG. 10 is a diagram schematically showing the architecture of a LFSR, which can generate a pattern signal with a cycle of 2ⁿ−1 bits;

FIG. 11 is a flowchart of the method of the present invention;

FIG. 12 is a diagram demonstrating the process of the present invention with an example; and

FIG. 13 is a block diagram schematically showing the architecture of a card reader.

### DETAILED DESCRIPTION OF THE INVENTION

The present invention modifies the analog/digital architecture of the original circuit to implement the addition of redundant bits and the adaptation of clock frequency to realize a cryptographic function. The cryptographic method of the present invention can combine with the existing digital security mechanisms to achieve a multi-fold security function and promote the threshold of decrypting the security system.

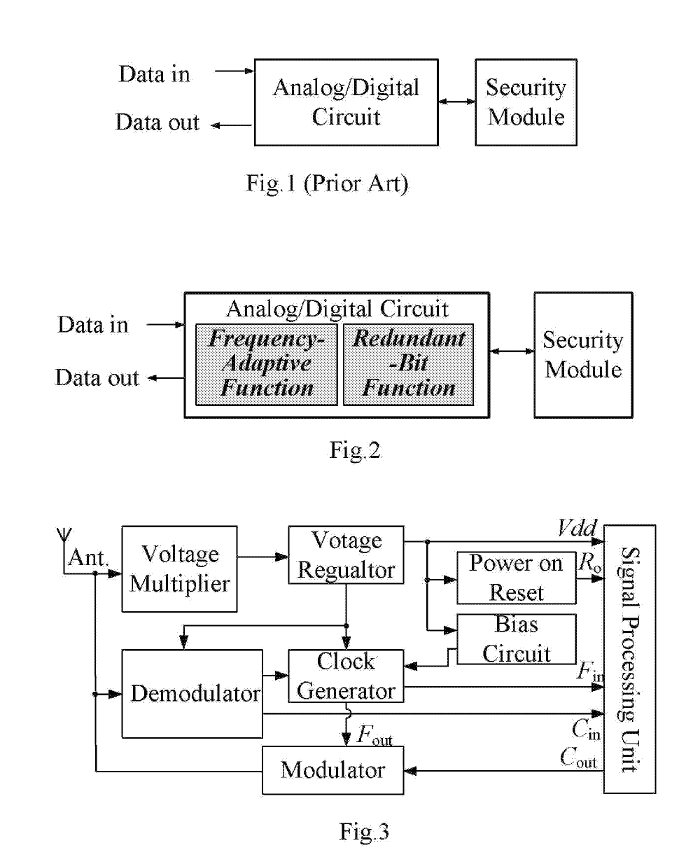

Refer to FIG. 1 a block diagram showing a conventional integrated system containing analog/digital circuits and a security module. The analog circuit performs demodulation, amplification, voltage-stabilization, etc., and generates clock signal for the succeeding digital circuit. The digital circuit performs logic calculations, data storage, control, instructions, etc., to facilitate data processing. The security module utilizes a special algorithm to encrypt data to prevent data from being stolen and protect personal privacy.

Refer to FIG. 2 a block diagram showing the circuit architecture implementing the present invention with a redundant-bit function and a frequency-adaptive function. The redundant-bit function adds redundant bits to the original bit sequence to increase the total bit number of the bit sequence. The frequency-adaptive function modifies the clock frequency (the signal transmission rate) to avoid transmission delay. The redundant bits may be generated by a random number generator. The emerged bit sequences can further combine with other cryptographic mechanisms to realize a multi-fold security function.

The process of the cryptographic method of the present invention comprises the following steps: determining the bit number of the original bit sequence and the bit number of a redundant bit sequence; merging the redundant bit sequence with the original bit sequence; modifying the original clock frequency to attain a clock frequency adaptive to the merged bit sequence; and outputting the merged bit sequence and the adaptive clock frequency for further processing. The original bit sequence may be a non-encrypted bit sequence or a bit sequence encrypted with a self-invented method or an existing encryption method, such as AES (Advanced Encryption Standard), DES (Data Encryption Standard), or the like. The redundant bit sequence may be an all-0 bit sequence, an all-1 bit sequence, a PRBS (Pseudo-Random Binary Sequence), or another more complicated bit sequence, as long as it meets the bit number defined by the user. The PRBS can be realized with an LFSR (Linear Feedback Shift Register). The bits of the redundant bit sequence may be arbitrarily distributed in the original bit sequence; for example, the methods of integrating the redundant bit sequence with the original bit sequence may be that the redundant bit sequence is arranged in before the original bit sequence, that the redundant bit sequence is arranged in behind the original bit sequence, or that the single bits of the redundant bit sequence are separately and arbitrarily interposed between the bits of the original bit sequence. The clock frequency is generated by a clock generator, such as an oscillator, a frequency synthesizer, a phase-lock loop, or any device able to generate the required clock frequency, wherein the frequency of the oscillator can be varied by voltage, current or a control circuit. The process of the cryptographic method of the present invention can be described by a computer language and expressed by Program (1):

| | |
|---|---|
| for (k = 1, k ≦ (the length of A)/ M ,k + +){ | (1) |
| C_{(k-1)(M+N)+1} ~ C_{k(M+N)} ← [A_{(k-1)M+1} ~ A_{kM}]+[B_{(k-1)M+1} ~ B_{kM}]; | |
| } | |
| f′ ← f ×(the length of A + B)/(the length of A); | |
| return(C,f′) | |

wherein A denotes the original bit sequence, B the redundant bit sequence, C the emerged bit sequence, f the original clock frequency, f′ the adaptive clock frequency, M the bit number of the original bit sequence, and N the redundant bit number. Below, several embodiments are used to exemplify the method of the present invention.

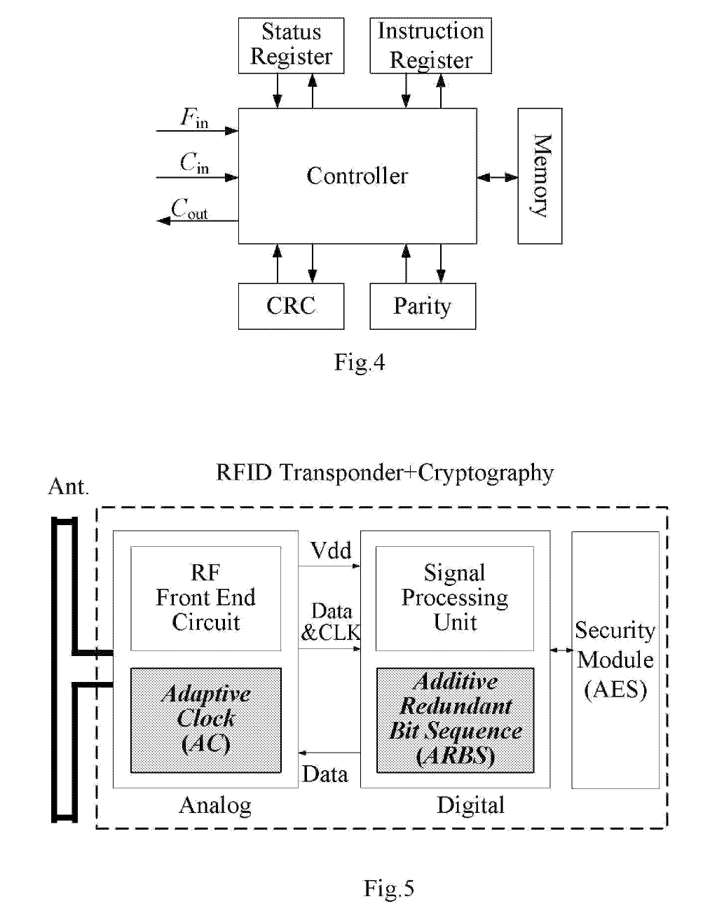

The embodiment that the present invention is applied to an RFID (Radio Frequency Identification) tag is to be described in the following. Generally, the circuit of an RFID tag comprises a RF (Radio-Frequency) front-end circuit and a digital signal processing unit. Refer to FIG. 3 and FIG. 4 for the architectures of a RF front-end circuit and a digital signal processing unit. A RF front-end circuit usually comprises a voltage multiplier, a voltage regulator, a bias circuit, a power-on reset circuit, a clock generator, and an ASK (Amplitude-Shift Keying) modulator/demodulator. The abovementioned elements or circuits are briefly described below.
(1) Voltage multiplier: The function of the voltage multiplier is to convert electromagnetic wave into DC voltage powering the other elements of the RFID tag.
(2) Voltage regulator: As the distance between the reader and the tag is unfixed, the voltage output by the voltage multiplier is also indefinite. The function of the voltage regulator is to provide a stable operational voltage.
(3) Bias circuit and Power-on reset circuit: The bias circuit is to generate the bias points needed by the clock generator, the power-on reset circuit and the ASK demodulator. The power-on reset circuit is to provide a reset signal for the digital signal processing unit, wherein the reset signal is generated by the charge/discharge of a capacitor and the function of a current mirror.
(4) Clock generator: In order for the rear end of the demodulated signal to generate an external feedback signal within a fixed period of time, the input signal for the clock generator must be a demodulated signal. Then, the clock signal has a fixed cycle, and the front-end of RF circuit can thus generate an external clock and further produce required instructions and output signals. The clock is not correlative with the operational frequency of the antenna. If the antenna is changed, the system inside the tag still works under the same clock frequency. Therefore, the clock generator, which influences all the activities of the modulator and the digital circuit, is an indispensable circuit for the tag. The clock generator, which is mainly implemented with a frequency synthesizer, generates the required clock signals Fᵢₙ and Fₒᵤₜ, wherein Fᵢₙ is transmitted to the digital signal processing unit and functions as the clock signal of the digital circuit, and Fₒᵤₜ is transmitted to the modulator for modulation.
(5) Modulator/Demodulator: The demodulator is to convert the electromagnetic signal into the signal that the digital circuit can read, and the modulator is to convert digital data into electromagnetic signal that is then sent to the antenna, so that intercourse between the tag and the reader can be effectively performed.
(6) Digital signal processing unit: The digital signal processing unit is mainly to process instructions and ID code, and the operation thereof is based on an anti-collision algorithm. When signal enters the controller, the controller sends signal to drive the other circuits to operate according to the instructions stored in the instruction register. The memory thereof stores data and ID code for identification tasks.

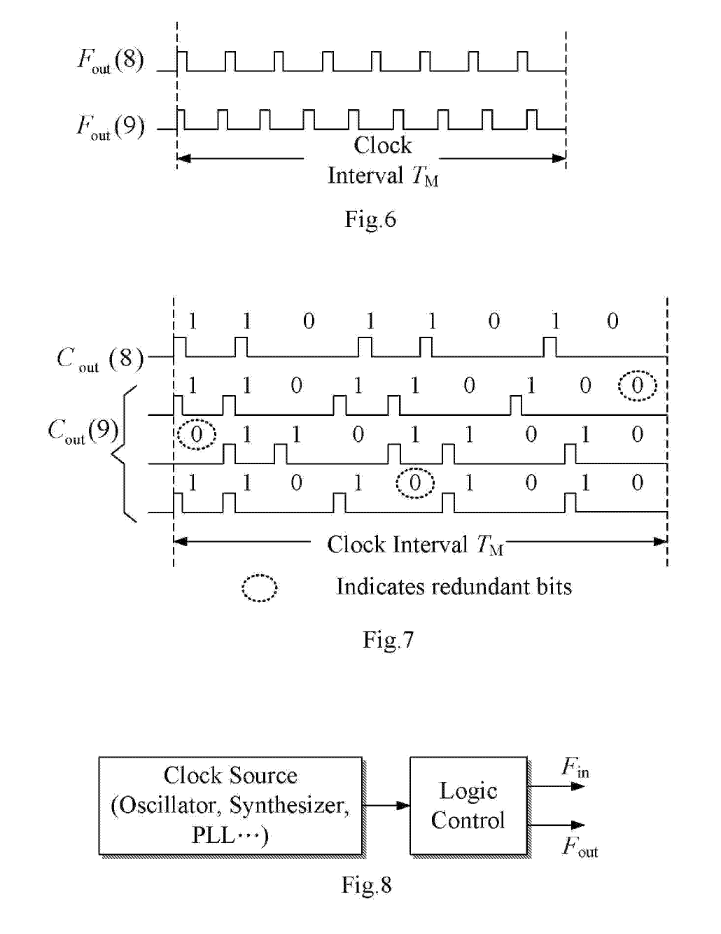

When the present invention is applied to the abovementioned passive-tag circuit, the circuit shown in FIG. 5 can be obtained. In one aspect of this embodiment, the clock frequency Fₒᵤₜ of the RF front-end circuit is modified, which is implemented by the AC (Adaptive Clock) function. For a given interval T_{M}, the clock Fₒᵤₜ originally having M clock cycles is modified to have M+N clock cycles; the original clock (M clock cycles) is denoted by Fₒᵤₜ(M), and the modified clock (M+N clock cycles) is denoted by Fₒᵤₜ(M+N). FIG. 6 shows the case that M=8 and N=1, wherein the number of cycles is increased from 8 to 9 for a given interval T_{M}. The additional N cycles corresponds to N redundant bits, which are generated by the digital circuit. The signal is sent out by the tag and received by the reader. In the reader, the original bits (M bits) and the additional bits (N bits) are separated, processed, and then controlled/analyzed by the rear-end middleware. The values of M and N may be assigned by the designer or the manufacturer. The greater the value of N, the higher the clock frequency, and also more the redundant bits. The more the redundant bits, the more the data the digital signal processing unit has to process, which requires a larger memory. Thus, the decryption of the signal becomes more difficult, and the threshold of detecting privacy or penetrating an information security system is also greatly promoted, which will provide the user with more protection. Contrarily, the smaller the value of N, the fewer the data the digital signal processing unit has to process, which will reduce the complexity of hardware design. In another aspect of this embodiment, the digital data Cₒᵤₜ of the digital signal processing unit is modified. For a given interval T_{M}, the digital data Cₒᵤₜ originally having M bits is modified to have M+N bits; the original digital data (M bits) is denoted by Cₒᵤₜ(M), and the modified digital data (M+N bits) is denoted by Cₒᵤₜ(M+N). FIG. 7 shows the case that M=8 and N=1, wherein the redundant bits are set to be 0. In the present invention, the redundant N bits can be implemented with a PRBS (Pseudo-Random Binary Sequence) method, which can be easily facilitated with a circuit and has a low complexity. Besides, the positions of adding the redundant bits, which will influence the activities of the digital circuit, may be determined by the designer or the manufacturer.

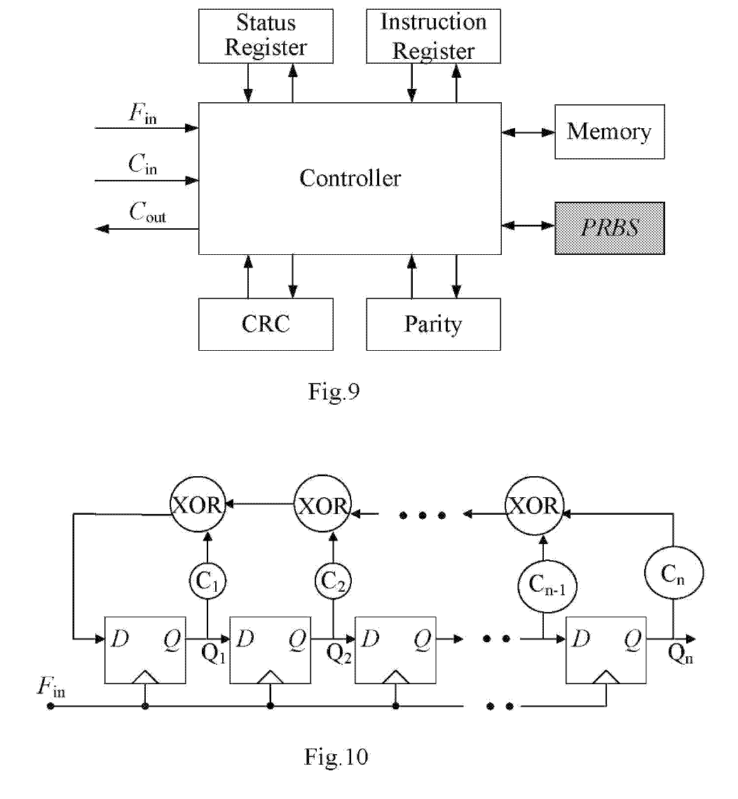

When the present invention is applied to a passive tag, two mechanisms are used to facilitate the method of the present invention: a clock signal generator in the RF front-end circuit and a redundant-bit mechanism in the digital signal processing unit. FIG. 8 is a diagram schematically the clock signal generator, which may be realized with a voltage-controlled oscillator, a frequency synthesizer, a phase-lock loop, etc. FIG. 9 is a diagram schematically the redundant-bit mechanism, which may be realized with an LFSR (Linear Feedback Shift Register). FIG. 10 shows an LFSR, which can generate a pattern signal with a cycle of 2ⁿ−1 bits, wherein n is the number of the cascaded flipflops.

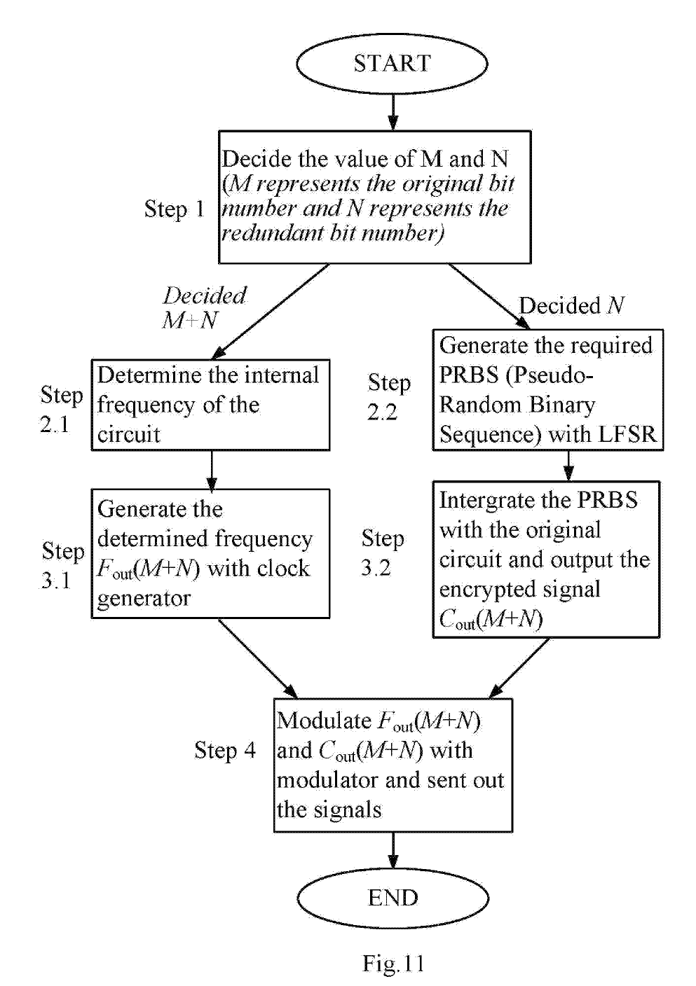

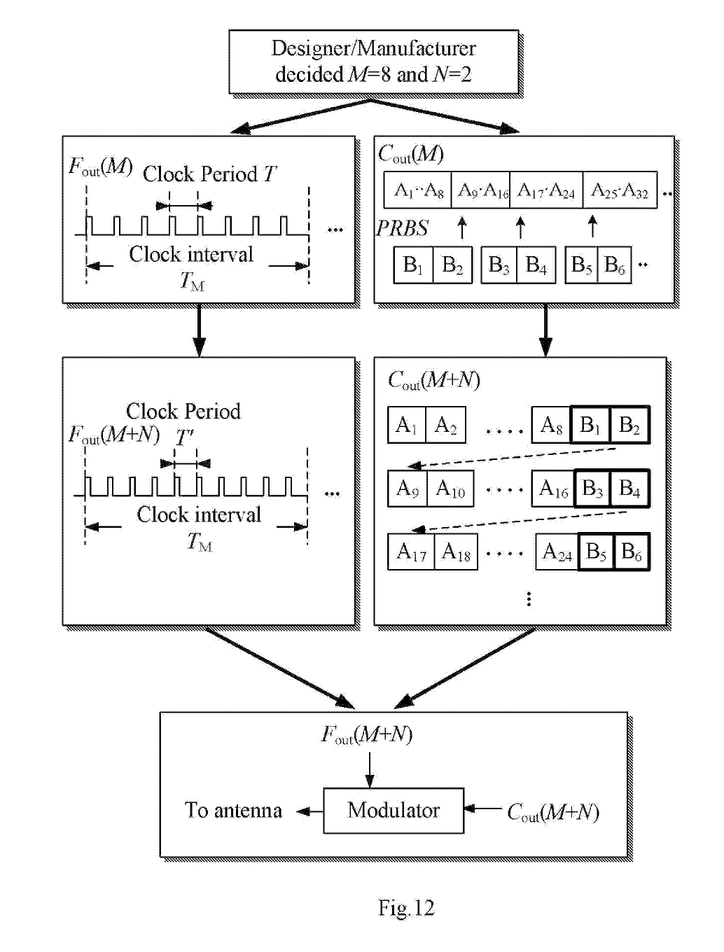

Refer to FIG. 11 for the flowchart of the method of the present invention, which comprises four steps. In Step 1, the redundant bit sequence and the clock signal are determined by the designer or the manufacturer; the bit number (A) of the original bit sequence and the bit number (N) of the redundant bit sequence are also determined. The flowchart branches in two directions in Step 2 and Step 3: one direction pertains to the cryptographic mechanism of modifying clock, including Step 2.1 and Step 3.1, and the other direction pertains to the cryptographic mechanism of adding redundant bits, including Step 2.2 and Step 3.2. In Step 2.1, the internal clock frequency of the circuit is determined. In Step 3.1, the clock generator generates the required clock signal. In Step 2.2, the LFSR generates the required PRBS (Pseudo-Random Binary Sequence), and the consideration for the circuit architecture and the numbers of the flipflops and logic gates is involved in this step. In Step 3.2, the sequence obtained in Step 2.2 is integrated with the original digital circuit, and the encrypted signal is output. In Step 4, the clock signal obtained in Step 3.1 and the bits generated by the digital circuit in Step 3.2 are modulated by the modulator and sent out from the antenna; then the reader receives the signal and demodulates the signal to obtain the correct bit signal. Suppose that the original signal meets the standard of ISO18000-6 and adopts a digital security mechanism AES-128, and that M=8, N=2, and the N redundant digits are added behind the original signal. Let the 128-bit AES-encrypted signal be denoted by “A₁A₂A₃. . . A₁₂₈”, and let the redundant bit sequence be denoted by “B₁B₂. . . Bₓ”, wherein the redundant bit sequence is the PRBS generated by an LFSR. According to the present invention, N redundant bits are added to each M bits of the original signal. Herein, 2 redundant bits are added to each 8 bits of the original signal. Thus, the first 8 bits “A ₁A₂A₃A₄A₅A₆A₇A₈” of the original signal is combined with 2 redundant bits “₁B₂” to obtain “A₁A₂A₃A₄A₅A₆A₇A₈B₁B₂” firstly, and the time occupied by the 10 bits is the same as that occupied by the 8 bits of the original signal. Next, the second 8 bits of the original signal “A₉A₁₀A₁₁A₁₂A₁₂A₁₃A₁₄A₁₅A₁₆” is combined with 2 redundant bits “B₃B₄” to obtain “A₉A₁₀A₁₁A₁₂A₁₃A₁₄A₁₅A₁₆B₃B₄”. The abovementioned procedure is repeated until the original signal is exhausted. The process of the present invention can be further demonstrated with the abovementioned example. Refer to FIG. 11 and FIG. 12. In Step 1, let M=8, and N=2. In Step 2.1 and Step 3.1, the clock generator is modified, and the original clock signal Fₒᵤₜ(M) having the frequency f is changed to be an adaptive clock signal Fₒᵤₜ(M+N) having the frequency f′, wherein 10×f=8×f′. In Step 2.2 and Step 3.2, the LFSR is used to generate PRBS, and the position of the redundant bits relative to the original signal Cₒᵤₜ(M) is determined, and then the emerged signal Cₒᵤₜ(M+N) is generated. In Step 4, the adaptive clock signal Fₒᵤₜ(M+N) and the emerged signal Cₒᵤₜ(M+N) are processed by the modulator to obtain the modulated signal, which is further transmitted to the reader via the antenna for further processing. As shown in FIG. 12, the present invention converts the original clock signal Fₒᵤₜ(M) and the original bit sequence Cₒᵤₜ(M) into the required Fₒᵤₜ(M+N) and Cₒᵤₜ(M+N), and sends them to the modulator for modulation.

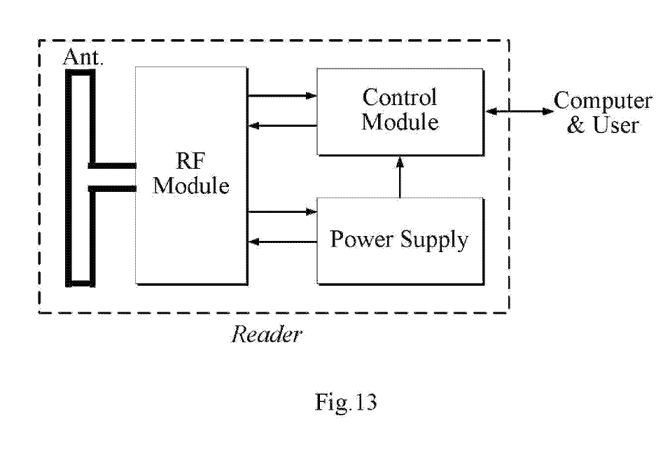

Refer to FIG. 13. On the recipient side, the reader receives the signal transmitted by the tag and performs the communication management between the reader and the tag. The control module of the reader manages timing and data and decodes the signals of Fₒᵤₜ(M+N) and Cₒᵤₜ(M+N) to obtain the corresponding Fₒᵤₜ(M) and Cₒᵤₜ(M), which are then sent to the host computer for the succeeding processing and analysis.

Those described above are only the preferred embodiments to exemplify the present invention. It is not intended to limit the scope of the present invention. Any equivalent modification or variation according to the spirit of the present invention is to be also included within the scope of the present invention.

What is claimed is:

1. A cryptographic method for a circuit, comprising the following steps:
determining bit number of an original bit sequence and bit number of a redundant bit sequence;
combining said original bit sequence and said redundant bit sequence to form a new bit sequence;
modifying clock frequency of said original bit sequence to obtain a new clock signal adaptive to addition of said redundant bit sequence; and
transmitting said new bit sequence and said new clock signal to rear end for succeeding processing.

2. The cryptographic method for a circuit according to claim 1, wherein said original bit sequence is a non-encrypted bit sequence or a bit sequence encrypted with a self-invented method or an existing encryption method.

3. The cryptographic method for a circuit according to claim 1, wherein clock generator for modifying the clock frequency is an oscillator, a frequency synthesizer, a phase-lock loop, or any device able to generate required clock frequency.

4. The cryptographic method for a circuit according to claim 3, wherein frequency of said oscillator is controlled by voltage, current or a control circuit.

5. The cryptographic method for a circuit according to claim 1, wherein said redundant bit sequence is an all-0 bit sequence, an all-1 bit sequence, a pseudo-random binary sequence, or another more complicated bit sequence, which has required bit number.

6. The cryptographic method for a circuit according to claim 5, wherein said pseudo-random binary sequence is realized with a linear feedback shift register.

7. The cryptographic method for a circuit according to claim 1, wherein position where said redundant bit sequence is added to said original bit sequence is arbitrary.

8. The cryptographic method for a circuit according to claim 7, wherein said redundant bit sequence is added to before said original bit sequence, or said redundant bit sequence is added to behind said original bit sequence, or single bits of said redundant bit sequence are separately and arbitrarily interposed between bits of said original bit sequence.

9. The cryptographic method for a circuit according to claim 1, wherein said succeeding processing includes signal transmission, signal compression, signal modulation, or signal analysis.
